(19) United States
(12) Patent Application Publication
(10) Pub. No.: US 2014/0175027 A1
(43) Pub. Date: Jun. 26, 2014

(54) FUEL SYSTEM WITH ELECTRICALLY HEATED FILTER SCREEN

(71) Applicant: UNITED TECHNOLOGIES CORPORATION, Hartford, CT (US)

(72) Inventor: Taylor Fausett, San Diego, CA (US)

(73) Assignee: United Technologies Corporation, Hartford, CT (US)

(21) Appl. No.: 13/725,252

(22) Filed: Dec. 21, 2012

(51) Int. Cl. B01D 35/00; B01D 35/18

(52) U.S. Cl. CPC B01D 35/005; B01D 35/18
USPC 210/774; 210/185

(57) ABSTRACT

A filter includes a filter screen with at least one hollow member and a heating element within at least one hollow member.

### BACKGROUND

The present disclosure relates to a fuel system, and more particularly to a filter therefor.

Aircraft fuel systems, because of the wide range of environmental conditions in which aircraft operate, may be susceptible to ice clogging. The ice, in rare instances, may lodge in servo valves and other calibrated fuel system components.

Conventional aircraft fuel system filters may be limited in ice management. Either the filter is fine enough to filter debris and may be susceptible to a relatively significant pressure drop or the filter is designed with respect to ice and is inherently too coarse to filter debris to a desired level. Ice separators that rely solely on geometry to accomplish the separation of ice and debris with no filter screen may also be ineffective because of the wide range of fuel flow speeds typical of fuel systems for aircraft gas turbine engines.

Icing may thus not only be an issue for aircraft main engines, but may an even more acute issue for aircraft Auxiliary Power Units (APUs) as APUs typically rest in flight at a no flow condition, may gather ice, then may suddenly be tasked with operation in a freezing condition.

### SUMMARY

A filter according to one disclosed non-limiting embodiment of the present disclosure includes a filter screen with at least one hollow member and a heating element within the at least one hollow member.

In a further embodiment of the foregoing embodiment, the filter screen is manufactured of a metal alloy. In the alternative or additionally thereto, in the foregoing embodiment the heating element does not contact a fuel. In the alternative or additionally thereto, in the foregoing embodiment the heating element heats a fuel via conduction through the filter screen.

In a further embodiment of any of the foregoing embodiments, the filter screen is in-line with a fuel conduit.

In a further embodiment of any of the foregoing embodiments, the filter screen prevents passage of particles greater in size than 1500 microns.

An aircraft fuel system according to another disclosed non-limiting embodiment of the present disclosure includes a fuel conduit and a filter screen in-line with the fuel conduit, the filter screen heated via conduction.

In a further embodiment of the foregoing embodiment, the filter screen is manufactured of a metal alloy.

In a further embodiment of any of the foregoing embodiments, the system further comprising a heating element within the filter screen. In the alternative or additionally thereto, in the foregoing embodiment the heating element is within the filter screen, the filter screen within a fuel filter. In the alternative or additionally thereto, in the foregoing embodiment the heating element heats a fuel via conduction through the filter screen. In the alternative or additionally thereto, in the foregoing embodiment the filter screen provides a pressure drop of less than 0.5 psi. In the alternative or additionally thereto, in the foregoing embodiment the filter screen prevents passage of particles greater in size than 1500 microns.

In a further embodiment of any of the foregoing embodiments, the fuel filter is upstream of a heat exchanger.

A method of filtering, according to another disclosed non-limiting embodiment of the present disclosure includes heating a filter screen in communication with a fluid via conduction.

In a further embodiment of the foregoing embodiment, the method further comprising locating the filter screen in contact with a fuel.

In a further embodiment of any of the foregoing embodiments, the method further comprising locating the filter screen in-line with a fuel conduit.

In a further embodiment of any of the foregoing embodiments, the method further comprising locating the filter screen in-line with a fuel conduit.

In a further embodiment of any of the foregoing embodiments, the method further comprising locating a heating element within at least one hollow member of the filter screen.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a fuel system for a gas turbine engine; and

FIG. 2 is an enlarged sectional view of an Electrically Heated Filter Screen (EHFS).

### DETAILED DESCRIPTION

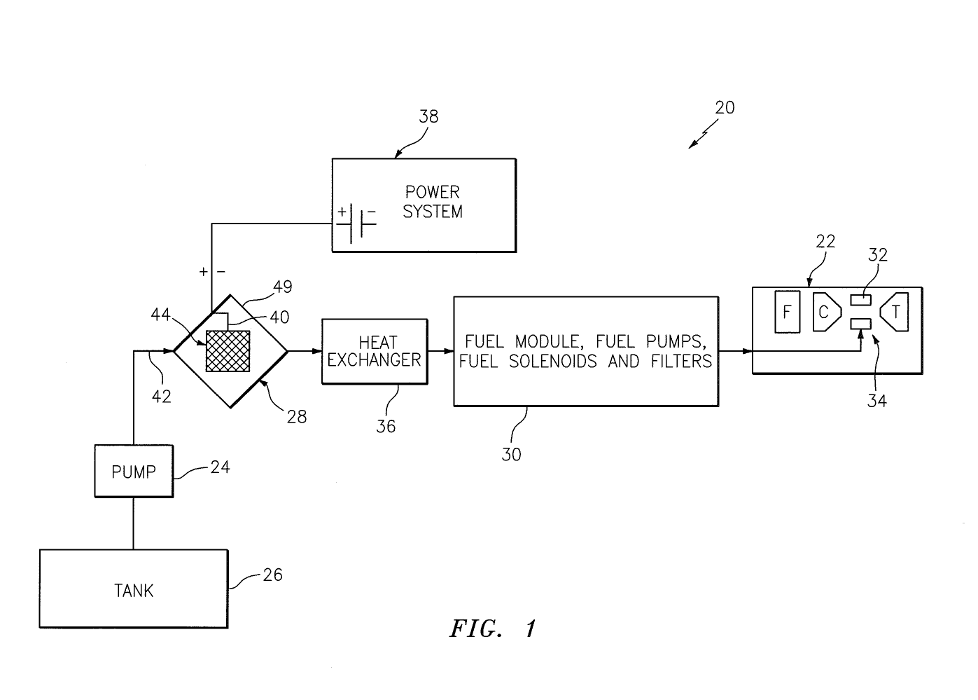

FIG. 1 schematically illustrates a fuel system 20 for an engine 22. The engine 22 may be, for example but not limited to, a gas turbine engine utilized for propulsion of an aircraft, a gas turbine engine utilized as an auxiliary power unit (APU) or other system.

The fuel system 20 generally includes a main pump 24 to supply fuel from a relatively low pressure fuel source 26 through a filter 28 to a fuel subsystem 30 thence to a fuel manifold 32 in a combustor section 34 of the engine 22. The fuel subsystem 30 may include various components such as fuel modules, high-pressure pumps, solenoid valves, metering valves, shut-off valves, spill valves, and other filters. It should be appreciated that various other, systems, subsystems and components may alternatively or additionally be provided and are contemplated as included by the fuel subsystem 30.

The filter 28 may also be immediately upstream of a heat exchanger 36 that is optionally employed within the fuel system 20. It should be appreciated that the heat exchanger 36 may be directly associated with the engine 22 and/or distributed elsewhere in the larger system 20. The heat exchanger 36 may alternatively or additionally include a multiple of heat exchangers distributed throughout the system.

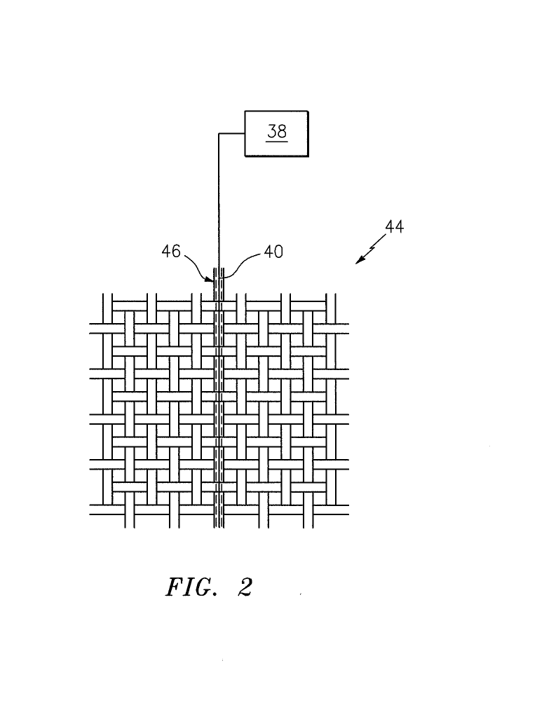

A power system 38 communicates electrical power to various subsystems inclusive of a heating element 40 within a filter screen 44 of the filter 28 to provide an Electrically Heated Filter Screen (EHFS) (FIG. 2). It should be appreciated that the power system 38 may be an aircraft electrical system, a subsystem of the fuel system 20 or other subsystem. The EHFS, in one disclosed non-limiting embodiment, may be an in-line filter in a fuel conduit 42, or, in another disclosed non-limiting embodiment, a filter array that is defined along a relatively long length within the fuel conduit 42. That is, the filter screen 44 does not substantially redirect the fuel within the fuel conduit 42. Furthermore, the filter screen 44 need not be a planar member.

With reference to FIG. 2, the filter screen 44 includes at least one hollow member 46. The hollow member 46 contains the heating element 40 to heat the filter screen 44 via conduction. It should be appreciated that although a single straight heating element 40 is schematically illustrated, any number and configuration of heating elements 40 to include a heating element 40 within member of the filter screen 44.

Even though the filter screen 44 is in contact with the fuel, the heating element 40 does not contact the fuel. The filter screen 44 may be manufactured of a metal alloy to facilitate thermal conduction. In one disclosed non-limiting embodiment, the filter screen 44 provides a pressure drop of less than 0.5 psi and prevents passage of particles greater in size than 1500 microns.

The EHFS will not clog with ice under icing conditions because of the unique electrically heated filter screen 44. The EHFS also provides a defense to ice and debris at the lowest possible pressure drop which may be particularly beneficial in the upstream sections of the fuel system 20. The embedded heating element 40 permits the filter screen 44 to be rated at pressures as high as the fuel conduit 42 and allows the electrical portion of the filter screen 44 to be segregated from the fuel. The EHFS beneficially incorporates all the advantages of a fuel system filter screen yet eliminates the potential for icing and provides the advantages of an Ice and Debris Separator without the disadvantages of additional fluid volume and weight. The fuel system 20 may also be less complicated in that, for example, systems of filters, recirculation flows, larger debris handling boost pumps, and coarse filters may be eliminated.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims It is therefore to be understood that within the scope of the appended claims, the disclosure may be practiced other than as specifically described. For that reason the appended claims should be studied to determine true scope and content.

What is claimed is:

1. A filter comprising:
a filter screen with at least one hollow member; and
a heating element within said at least one hollow member.

2. The filter as recited in claim 1, wherein said filter screen is manufactured of a metal alloy.

3. The filter as recited in claim 2, wherein said heating element does not contact a fuel.

4. The filter as recited in claim 2, wherein said heating element heats a fuel via conduction through said filter screen.

5. The filter as recited in claim 1, wherein said filter screen is in-line with a fuel conduit.

6. The filter as recited in claim 1, wherein said filter screen prevents passage of particles greater in size than 1500 microns.

7. An aircraft fuel system comprising:
a fuel conduit; and
a filter screen in-line with said fuel conduit, said filter screen heated via conduction.

8. The system as recited in claim 7, wherein said filter screen is manufactured of a metal alloy.

9. The system as recited in claim 7, further comprising a heating element within said filter screen.

11. The system as recited in claim 9, wherein said heating element is within said filter screen, said filter screen within a fuel filter.

12. The system as recited in claim 9, wherein said heating element heats a fuel via conduction through said filter screen.

13. The system as recited in claim 9, wherein said filter screen provides a pressure drop of less than 0.5 psi.

14. The system as recited in claim 9, wherein said filter screen prevents passage of particles greater in size than 1500 microns.

15. The system as recited in claim 1, wherein said fuel filter is upstream of a heat exchanger.

16. A method of filtering comprising:
heating a filter screen in communication with a fluid via conduction.

17. The method as recited in claim 16, further comprising locating the filter screen in contact with a fuel.

18. The method as recited in claim 16, further comprising locating the filter screen in-line with a fuel conduit.

19. The method as recited in claim 16, further comprising locating the filter screen in-line with a fuel conduit.

20. The method as recited in claim 16, further comprising locating a heating element within at least one hollow member of the filter screen.
